(19) United States
(12) Patent Application Publication
(10) Pub. No.: US 2004/0262231 A1
(43) Pub. Date: Dec. 30, 2004

(54) Method to treat water with dissolved gas

(76) Inventors: Viktor Mikhailovskii, Prescott (CA); Olga Myhaylovska, Waterloo (CA)

Correspondence Address: Viktor Mikhailovskii, 47 Westroyal Rd, Toronto, ON, M9P 2C4, CA

(21) Appl. No.: 10/601,918

(22) Filed: Jun. 24, 2003

(51) Int. Cl. C02F 1/24

(52) U.S. Cl. 210/704; 210/221.2

(57) ABSTRACT

A process to treat water from pollutants by non-stabilized gas bubbles is claimed. Polluting agents are concentrated within thin top water layer and later removed from the treated water either with this top water layer or by a flocculation and further precipitation. The treatment process could go on a continuous basis and be productive. An Apparatus utilizing a water tower for the continuous treatment is claimed.

### BACKGROUND OF THE INVENTION

The present invention relates to the fields of water treatment for drinking or any other purposes from polluting agents by a dissolved gas.

In the USA currently most of the water for drinking is treated by a gravitational method. In this method flocculants are added to the water to destabilize colloids that further flocculate and eventually precipitate. Because most of pollutants other then particles are adsorbed by these colloids this method removes these non particulate pollutants from the water as well. The amount of added flocculants is directly proportional to the volume of treated water. The price of these flocculants contributes a major part of drinking water total cost and for very large volumes of water this price is high.

Another problem with the conventional gravitational or sedimentation method is that it does not have an ability to treat water from certain pollutants like those ones of a biological origin. Other methods have to be utilized additionally to the gravitational method, for example adsorption which further increases the total drinking water cost.

A method of Dissolved Air Flotation (the DAF) is well known to treat water from contaminating agents of a colloid size and of biological origin. The DAF provides several advantages over a sedimentation process and is widely used to separate solids from liquids in treatment and pre-treatment of wastewater. It could be operated on a continuous basis: the U.S. Pat. Nos. 4,902,429 and 5,055,184. Unfortunately the DAF cannot be used as a main treatment process in public water treatment systems because it is not productive enough and consecutively is not very popular in the USA.

There are two main reasons of this lack of productivity. The first one is a presence of a diffuser in this method. This diffuser slows the flow of water to a flotational cell from a gas saturation chamber where the high pressure of gas is necessarily maintained.

The second reason is the small size of the formed gas bubbles. Only small gas bubbles can be used to collect colloids because of a hydrodynamical restriction. Surfactants that are added to the water to stabilize gas bubbles prevent the same gas bubbles from growing. This small size makes gas bubbles rise to the surface very slow.

Contrary to the DAF the process of Water Streams Self-Purification (the SP) does not lack productivity. Thousands of liters of water per second were treated in our in-stream experiments and the process of water purification was almost instant. This process only partially resembles the GAF. In the SP most of the air bubbles formed there are not stable because in nature no surfactants are added to the water. More details about the SP experiments could be found in the following web publications: http://www.arxiv.org/find/physics/1/au:+mikhailovskii/0/1/0/all,past/0/1?skip=0 &query i d=9c1f8a7d75d1d60b.

These experiments were conducted in nature by installation of Froth Collecting Traps (the FCT) across water streams at selected sites. At that time all or at least a substantial part of the removed from the water contaminants were considered by us to be contained within the collected froth. The SP process was proposed to be used either for environment protection/remediation or drinking water treatment: Canadian Patent Applications # 2,277,540 and # 2,302,110.

However in the same experiments it was monitored that a vast majority of air bubbles decayed almost immediately after rising to the top and the volume of the collected froth did not increase after a short period of time. This implied a balance between the amounts of decayed air bubbles within the collected froth and newly delivered.

However all the time newly arrived froth delivered next portions of contaminates and if the remaining froth absorbed these contaminants then the concentration of contaminants within the froth had to grow indefinitely. This was obviously impossible and some other process responsible for contaminants removal from the froth had to take place. This process of the pollutants further removal from the froth makes a major difference between the mechanisms of the SP and the GAF.

Later experiments revealed that the SP method did not work at all or worked poorly at several tested sites, particularly when the FCT was installed downstream from waterfalls, dams or any other sites with a turbulent water movement at a site of froth collection. That demonstrated that just a froth collection alone was not sufficient enough for the claimed method to work.

In another experiment a second Froth Collecting Trap was installed downstream from the first one. Both of the installed traps collected froth. This fact implied that naturally occurring in the water surfactants, collected by the second FCT, bypassed the first FCT. These surfactants at the second site were either not collected by air bubbles at the first site or more likely released into the water after the decay of air bubbles at the first site of froth collection. The self-purification process however took place at a site of the first froth collection so a decay of air bubbles and consequent release of surfactants did not affect the process of contaminants removal, quite a contrary to flotation.

In the next experiment the FCT was installed at an angle to the current and there was an opening at the downstream end of the trap so the top water could move through it altogether with collected froth. This FCT still accumulated some froth along itself. This collected froth was also moved along the FCT by a top water current toward the opening. Finally the froth that moved along the FCT was released downstream through the opening in the FCT.

A clear track of the froth was monitored downstream from the FCT until the last of the air bubbles decayed. Chemical analyses of the water samples indicated that the self-purification process was taking place although the collected froth was eventually bypassing the FCT. This fact demonstrated that the froth released through the opening did not contain contaminants at the time of release.

In another set of experiments the FCT was installed at a site where water was moving fast at a center of the stream and there was a backwater current close the bank. The froth was moving along the FCT and later taken from the FCT upstream by the backwater current. Very little of the froth was present at any moment next to the trap and the froth decayed soon after being taken by the backwater current. Chemical analyses showed that the self-purification effect still took place there.

These experiments confirmed already formulated conclusion that a removal of the froth accumulated by the FCT was useless. Correspondingly it was considered that the claimed method could not be explained by a flotation alone. Consequently the FCT installation alone was insufficient for the claimed method to work. As a conclusion the Method claimed by the quoted Canadian Patent Application # 2,302,110 for drinking water treatment was considered as not to merit requirements for a patent granting and thus this patent application was abandoned.

Currently the authors consider a mechanism of the studied self-purification as the following. After some disturbances take place in the water, the air already dissolved there is no longer at equilibrium with the water. At this point the air molecules start to form bubbles. Present in the water colloid pollutant particles act as nuclei. Similar to any phase transition process this initial nuclei presences facilitate the process of bubbles formation.

Because of the absence of surfactants in the water or due to insufficient concentrations of these surfactants, the air bubbles continue to grow during the whole process, quickly becoming large enough to rise fast to the top, where they also quickly decay and leave the delivered pollutants on or close to a top of the water. Because of a very small size these contaminants do not precipitate at all or their precipitation rate is extremely small. With a constant delivery of new contaminants their concentration within a thin top water layer increases in time.

However this process of increase could continue only to a certain limit. A process of a concentration coagulation is well known—an increase in contaminants concentration increases a probability of coagulation. If a substantial amount of the contaminants is delivered to the top, eventually flocks would be formed there. Finally large and heavy flocks will rapidly precipitate.

From the mechanism presented it could be expected that there would be some time margin during which all the contaminants lifted to the top are comprised within a thin top layer of the water. The one process that could obstruct this concentration is mixing of this top layer with underlying water.

This happens most of the time in nature where as a result of turbulences air bubbles are formed and contaminants are delivered to the water top. If this top water layer is not immobilized by some obstacle than it moves downstream as well as the main water body. If downstream there are bottom obstacles to water movement this results in further turbulent mixing of the water layers. The lifted contaminants return to the water body. Only if the top water layer is immobilized than a constant delivery of new portions of contaminants would complete the SP process.

If at some site there is a big difference in velocity of the water movement this causes a lateral backwater current. However if a FCT is installed and a top water layer is immobilized but an adjacent water is moving fast, the same reason would cause a backward movement of the top water layer. This movement could be both vertical and lateral with eventual mixing of the top water layer with the water bulk. Thus for the described process of contaminants concentration within a thin top water layer both a turbulent and a circular mixing of water layers must not take place or be suppressed.

In the SP gas bubbles are formed if there are turbulences within the water. Providing that the water is moving fast these turbulences could be caused by any obstacles to water movement like rocks, boulders, steps, dams, etc. Dams actually could be used to cause any water to move rapidly enough for the SP method to be implemented. These turbulences could be achieved in a variety of well known ways, for example by some elongated elements put into the water like in the U.S. Pat. No. 5,514,284, or by water flowing through a section with a free fall of the water like in the U.S. Pat. No. 6,042,724, or by arranging a combination of turbulent and non-turbulent zones like in the U.S. Pat. No. 6,043,067.

It has to be noted that under normal conditions only very limited volume of gas is dissolved and only a part of this gas further forms gas bubbles. Thus in this scenario an amount of obtained gas bubbles would be sufficient only to deal with not very polluted raw water, or this method can be a step in some further technological chain of treatment processes.

Advantages of the SP are both productivity and cost effectiveness. A disadvantage is caused by water movement hydrodynamics. With substantial volumes of the treated water it is not easy to arrange that all portions of the water were evenly turbulized and treated uniformly. Due to the hydrodynamic changes it looks to be difficult to treat varying volumes of the water.

Another way to obtain gas bubbles is utilized in Gas Assisted Flotation (the GAF) where some gas under pressure is initially dissolved within the water and gas bubbles result from further pressure decrease. This way allows to obtain necessary gas bubbles for treatment of substantially polluted water. However dissolution of the gas in the water takes time and adds a technological step to the treatment process thus increasing the total cost.

The same way was utilized in water treatment method for pressure stabilized removal of pollutants in the U.S. Pat. No. 6,398,968. The method of this patent utilizes dissolution of gas under pressure with further pressure decrease, with simultaneous addition of ferric salt to remove arsenic species from the water. An addition of the ferric oxide within this method is principal because alone a concentration of arsenic there is not enough to form large flocks. Differently to the SP there is no accumulation of arsenic in a top water layer in an in-stream application of this method, and thus there have to be a substantial concentration of particles within the water to form flocks large to precipitate. Similar to the SP these precipitated flocks have to be later removed from a bulk of the water which would add to the total cost of water treatment.

A productivity of a Gas Assisted Flotation is limited by some slowing device, for example a diffuser, between a chamber where a high gas pressure is maintained and a flotational cell where the pressure is normal. This device is necessary only because of this pressure difference. At the same time it is well known that at a bottom of water tower a pressure is determined by the height of water column within this tower. This pressure is utilized for example in the U.S. Pat. No. 5,514,284 where water is flowing downstream through filtering stages forced by this pressure.

Thus if said chamber where water is under a high pressure is connected directly to a bottom of a water tower the pressure of the water column could compensate the high pressure within that chamber, either completely or partly. In the last case the water would be moving from the chamber through the water tower, rising while moving, this forced by the pressure difference. A violent eruption of the water will not take place in this case.

### BRIEF SUMMARY OF THE INVENTION

A basic idea of the presented method to treat water from polluting agents is to utilize non stable gas bubbles. These gas bubbles originate from molecules dissolved previously in the water. Initially these bubbles are small and are able to collect objects of a colloid size and large organic molecules i.e. objects that are very difficult to remove by conventional methods.

Being not stabilized these bubbles continue to grow while rising, thus contrary to a Dissolved Air Flotation the process of rise is fast. Delivered to a water top and released there contaminants because of a very small size do not precipitate substantially and are accumulated within a thin top water layer. Eventually these concentrated contaminants are removed with this top water layer for further treatment and thus a main water body is treated from these pollutants. Another option is a process of eventual aggregation and flocculation of delivered to a water top contaminants followed by a precipitation.

A process can be applied on a continuous basis and thus match in productivity a conventional gravitational or sedimentation method. An Apparatus for treatment by the disclosed method is presented. This Apparatus utilizes a principle of a water tower, thus avoiding any slowing device like a diffuser. This process can be used to treat fast large volumes of water contrary to a Dissolved Air Flotation. Because no chemicals are added to the water to treat it the process is cost effective comparing to a sedimentation method.

Brief Description of the Several Views of the Drawing.

A water treatment process takes place in a Tank 1 as it is presented by a Pic.1. A main part of said Tank 1 has a shape of a cylinder and a top part of said Tank 1 has a form of a cone. Water 7 fills almost all of a volume of said Tank 1. Some small Volume 6 within the conical part of said Tank 1 is occupied by a gas. A Propeller 3 mounted against a wall of said Tank 1 agitates said water and mixes it.

Gas bubbles within said water originate from gas molecules present in said water. The agitation of said water by said Propeller 3 causes turbulences within said water followed by a formation of gas bubbles. Contaminants within said water attach to said gas bubbles and said gas bubbles collect and deliver said contaminants to a water Top 8. Because no flocculants were added to said water said gas bubbles grow in size during rise to said water Top 8. In another preferred embodiment also presented by the Pic.1 said gas bubbles originate from gas previously dissolved in said water under pressure. Said gas is delivered by a Pipe 2. Said Pipe 2 has a form of a spiral with numerous small holes and said gas moves through said holes into said water and rises through said water.

Said gas bubbles decay on said water Top 8 and release delivered contaminants. As a result with time a top water layer will be enriched with said contaminants. When the treatment process is finished, a predetermined top volume of said water is drained through a separate drainage Valve 5. Said drainage Valve 5 is mounted against the wall close a top of the conical part of said Tank 1.

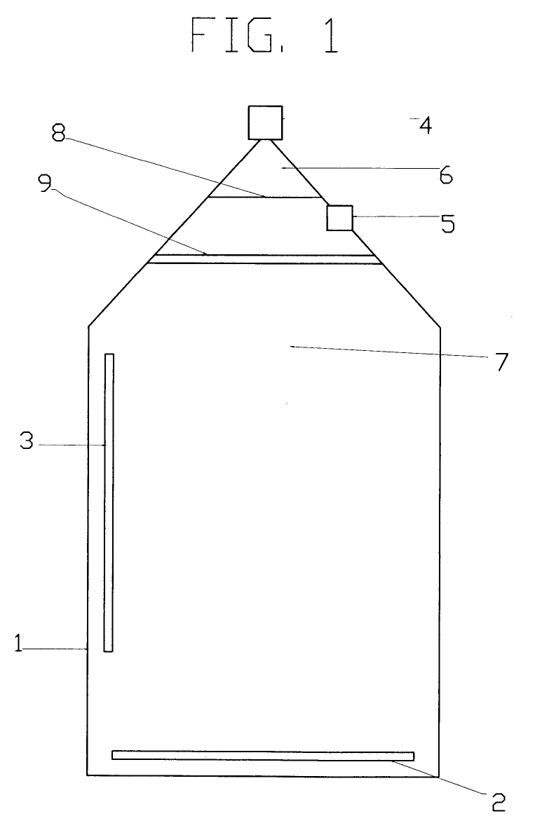

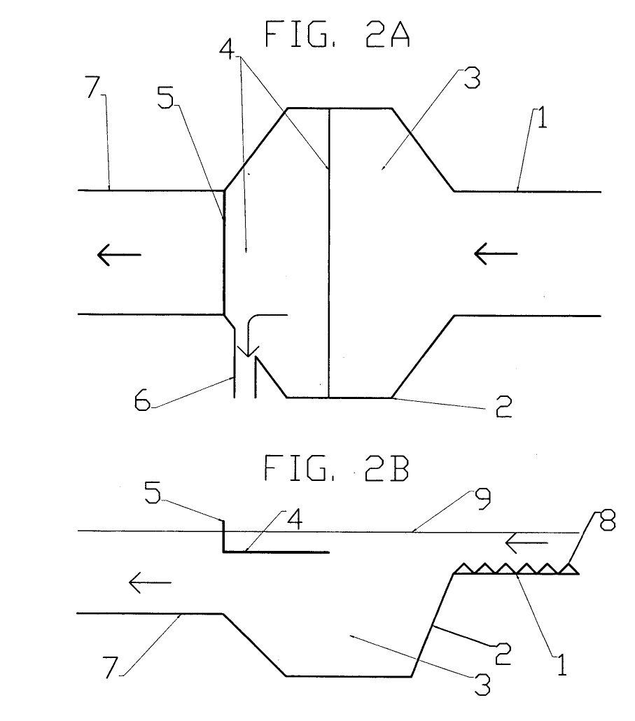

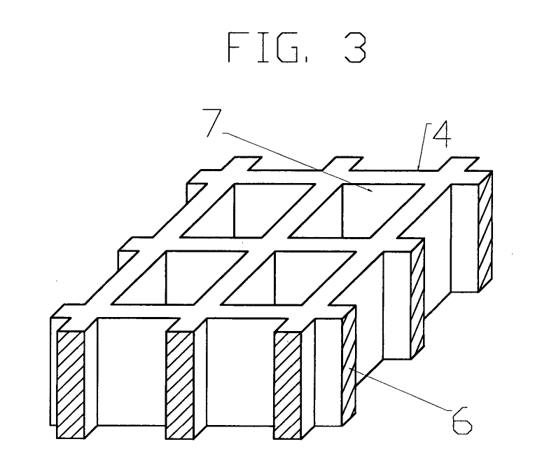

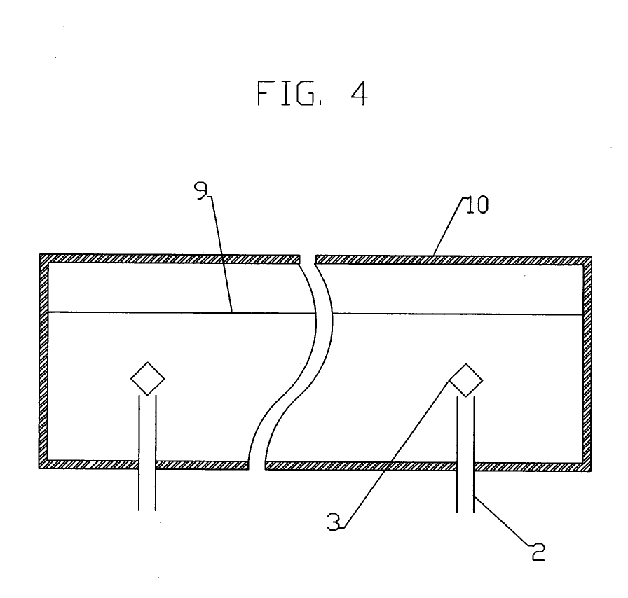

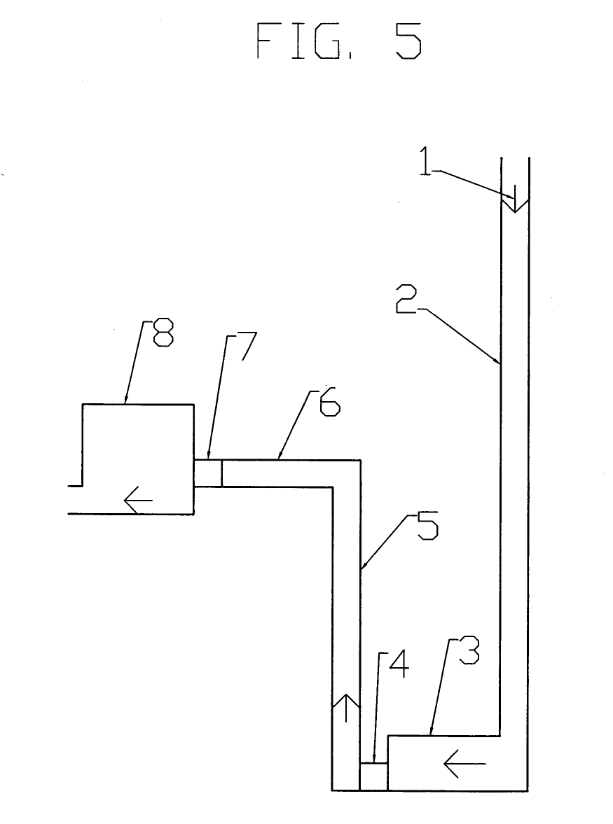

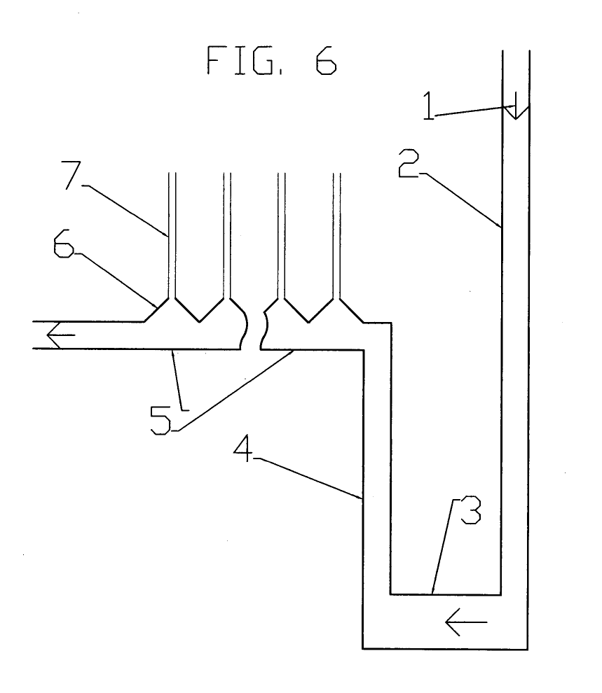

A Schematics of continuous treatment process is presented by a Pic.2. An Arrow shows the direction of the water movement there. A FIG. 1 is a view from the top while a FIG. 2 presents a side view of the process. Water initially flows fast by some shallow Channel 1. Obstacles 8 located at a bottom of said Channel 1 cause turbulences within said water. Next said water flows by a Pond 2. Said turbulences cause formation of gas bubbles within a Zone 3 of said Pond 2. Contaminants are attached to said gas bubbles and lifted to a water Top 9.

A Separator 4 is placed close to said water Top 9 within a next zone of said Pond 2. Said Separator 4 separates a thin top water layer with delivered contaminants from a main water body. Said main water body flows further by a Channel 7 while a vertical Bar 5 diverts said thin top water layer into a Pipe 6 for further treatment.

A preferred embodiment of said Separator 4 is presented by a Pic.3. Said Separator 4 is constructed in a form of plain thick lateral sheet. This sheet is constructed from Cells 7 in a form of lattice or honeycomb wherein said cells are opened from both ends and thus said gas bubbles can rise through said Separator 4. A height and width of said individual Cell 7 in said lattice or honeycomb is sufficient enough to prevent a turbulent movement of water through it. For said Separator 4 to be rigid enough Walls 6 of said Cells 7 have to be manufactured from an appropriate material, for example, but not limited to it, from steel or other metal.

Another preferred embodiment of said Separator 4 is as follows. Said Separator 4 consists from a lower and an upper parts. A lower part of said Separator 4 is similar to the previous embodiment presented by the Pic.3. Similarly to the embodiment presented by the Pic.3 this lower part has a form of a thick lateral Sheet 1. Differently to the embodiment presented by the Pic.3 opened from both ends Cells 7 are cone-shaped narrowing to the top.

Said Cells 7 are both long and narrow enough to suppress turbulences within said Cells 7. Said Cells 7 end into thin vertical Pipes 2. Above said lower part of said Separator 4 is an upper part of said Separator 4 presented by a Pic.4. Said upper part is a Tank 10. Said Pipes 2 end into said Tank 10 and do not reach water Surface 9 within said Tank 10. In one of preferred embodiments said vertical Pipes 2 are only within said Tank 10, thus said upper part of said Separator is mounted on the top of said lower part. In another preferred embodiment there is a substantial distance between said upper and lower parts and said upper and lower parts are connected only by long said Pipes 2.

Said gas bubbles rise through said Cells 7 and further trough said Pipes 2 and eventually reach said water Surface 9 within said Tank 5. Said gas bubbles decay at said water Surface 9 leaving delivered contaminants to float on or close to said water Surface 9. A continuous accumulation of said delivered contaminants at said water Surface 9 eventually results in an aggregation followed by a flocculation. Large flocks precipitate to the bottom of said Tank 10 and accumulate there to be further removed for treatment by any known method.

A Pic.5 presents a preferred embodiment of an Apparatus for a Gas Assisted Flotation Treatment of water. An Arrow 1 shows a direction of water movement through claimed Apparatus. Treated water initially flows down through a Shaft 2 of said Apparatus. Said treated water is saturated with gas under a predetermined pressure while moving trough a Tunnel 3 which is a Gas Dissolution Unit. In a case when water to be treated is already pressurized like water from a groundwater source it can enter said Gas Dissolution Unit or said Tunnel 3 directly without moving through said Shaft 2.

Said Tunnel 3 is connected by a Valve 4 to a bottom of a flotation Chamber. Said flotation Chamber comprises three Parts. A first part of said flotation Chamber is a water tower or a Shaft 5. Said Shaft 5 is both narrow and vertical. A length of said Shaft 5 is sufficient enough for a water pressure at the bottom of said Shaft 5 to compensate almost all of the gas pressure within said Tunnel 3 so no violent eruption of said water into said Shaft 5 takes place. An excess of said gas pressure within said Tunnel 3 over the water tower pressure within said Shaft 5 moves said treated water up through said Shaft 5 when said Valve 4 is opened. Said treated water rises fast through said Shaft 5 because of the small diameter of said Shaft 5.

A pressure drop within said Shaft 5 starts a formation of gas bubbles. However because this process of gas bubbles formation requires time when it takes place said treated water already flows by a second Part of said flotation Chamber. Said second Part of said flotation Chamber is a Pond 6. Said Pond 6 is horizontal and has a wide cross-section. At the end of said Pond 6 there is another Valve 7 that separates said Pond 6 from a third Part of said flotation Chamber Said third Part is a Pipe 8. Said Pipe 8 is narrow with a triangular cross-section. Surfactants could be added when or after said treated water flows through said Valve 4.

Because said Pond 6 is wide and shallow said water moves slow there and a retention time for said water within said Pond 6 is sufficient for all said gas bubbles to reach a top of said water. This retention time coincides with the time of the water saturation within said Gas Dissolution Unit. Froth is concentrated on said water top within said Pond 6.

When a Valve 7 is opened said water flows further into deep and narrow Pipe 8 wherein the accumulated froth with removed contaminants is separated from a main water body for further treatment. After said Pond 6 is empty said Valve 7 is closed and said Valve 4 is opened. Then the treatment cycle repeats.

A preferred embodiment of an Apparatus for a continuous water treatment with non-stable gas bubbles is presented by the Pic.6. An Arrow 1 shows a direction of water movement through said Apparatus. Said water enters said Apparatus by flowing down through a vertical Shaft 2. Said vertical Shaft 2 is connected at the bottom to a second Part of said Apparatus which is a Gas Saturation Unit. Said Gas Saturation Unit is a Tunnel 3 connected at the other end to a third Part of said Apparatus. In a case when water to be treated is already pressurized like water from a groundwater source it can enter directly said Gas Dissolution Unit. In a case when there is a desired concentration of dissolved gas within said water said water could enter the third part of said Apparatus directly, thus omitting said Gas Dissolution Unit.

While moving through said Tunnel 3 said water is saturated with gas delivered to said Tunnel 3 under a predetermined pressure. Eventually said water moves into a bottom part of a vertical Shaft 4 which acts as a Part 1 of a flotation Chamber. Said flotation Chamber comprises several parts following each other. Initially within said flotation Chamber said water rises by flowing through a Shaft 4. Said Shaft 4 is both vertical and narrow and a pressure drop within said Shaft 4 initiates a process of gas bubbles formation there. Because said water moves fast through said Shaft 4 gas bubbles only start to form and to collect pollutants within said Shaft 4.

Further said water flows through a Part 2 of said flotation Chamber which is a Tunnel 5. Said Tunnel 5 is of a much larger diameter then said Shaft 4. Thus said water moves much more slowly within said Tunnel 5 wherein also a majority of said gas bubbles are formed and reach a top of said water within said Tunnel 5. As it is presented by the Pic.6 a height of said Shaft 1 is substantially more then a height of said Shaft 4 and said water is under a substantial pressure within said Tunnel 5.

At a said Tunnel 5 top there is a set of conical Cavities 6. Said Cavities 6 end into Pipes 7. Said Pipes 7 are both thin and vertical. Said Pipes 7 end into the Tank 10 presented by the Pic.4, these Pipes 7 are the same with Pipes 2 of the Pic.4. Said substantial pressure is sufficient enough for said conical Cavities 6, and the following Pipes 7, and a part of said Tank 10 to be filled with water.

Said water flows further by said Tunnel 5 and leaves the described Apparatus. Said gas bubbles rise to the top of said Tunnel 5 and further though conical Cavities 6. Eventually said gas bubbles rise through Pipes 7 and decay at said water Top 9 within said Tank 10. As it was presented previously within said Tank 10 a removal of delivered by said gas bubbles contaminants takes place, either through a process of an aggregation and a precipitation, or as a flotation.

### DETAILED DESCRIPTION OF THE INVENTION

It should be clearly understood that the components of the presented invention as described herein could be arranged and designed in a variety of different configurations. Thus the following embodiments are not intended to limit the scope of the invention as it is claimed.

The term “water” herein designates any water with contaminants, pollutants, contaminating or polluting agents. The terms contaminants, pollutants, contaminating or polluting agents are further used interchangeably. Gas hereafter means any gas that firms later gas bubbles this gas being not necessarily air.

A speed of contaminants removal by the SP resulted from a lack of surfactants and a constant grow of air bubbles in size. Hence a first basic idea of the proposed method is to utilize a removal of pollutants by unstable gas bubbles. Initially to be small these gas bubbles have to be formed from molecules of gas present within treated water.

These gas molecules within treated water can have different origin One way is for these gas molecules to originate from some chemical reaction, taking place in the water after addition of a chemical. For example but not limited by this example the water was initially polluted with zinc carbonate. After an addition of phosphate carbon dioxide molecules will be released into the water accompanied by a formation of insoluble zinc phosphate. These gas molecules will form gas bubbles and zinc phosphate molecules will form particles, these particles will be attached to carbon dioxide gas bubbles or zinc phosphate can act as nuclei for bubbles to be formed.

In other case gas molecules can be previously dissolved within the treated water. This dissolution process can take place either under normal atmospheric pressure or said pressure could be increased like in a GAF and DAF. Gas bubbles formation can be caused either by a pressure drop (like in the GAF) or by turbulences within the treated water (like in the SP).

To obtain necessary turbulences the water could be also stirred for example by propellers, or turbines, or any similar objects within the water. Providing that the water is moving fast these turbulences could be caused by any obstacles to water movement like rocks, boulders, steps, dams, etc. Dams actually could be used to cause any water to move rapidly enough for the claimed method to be implemented. However to avoid big differences in lateral velocity and turbulences a waterfall after a dam is not an option. The water has to from this dam move via a ramp.

In the claimed method contrary to flotation no load of surfactants to later stabilize the gas bubbles is added to the water. At the same time surfactants-promoters of flotation could be added to the water prior a stage of gas bubbles formation only to promote an adhesion of these pollutants to the gas bubbles.

A vast majority of the gas bubbles in the claimed method decay almost immediately after reaching the water top, leaving the released contaminants there. These lifted contaminants could not be later removed with froth. Thus a second basic idea of the claimed method is based on a very slow precipitation rate of small contaminating agents. Providing a top water layer is not mixed with underlying main bulk of the treated water all lifted to the top contaminants would be located within some very thin top water layer for a considerable amount of time.

These collected contaminants have to be further removed with this top water layer. This top water layer could be later treated by any known method including several cycles of the claimed method for further concentration of pollutants within progressively smaller volumes of the water.

Another option to deal with concentrated within said top water layer pollutants is as follows. If said top water layer does not move at all or moves slowly with a constant delivery of new portions of contaminating agents there would be a concentration of these contaminants within said top water layer. This process of concentration eventually causes an aggregation of these small contaminants. Further such a concentration could result in large flocks formation followed by a precipitation of said flocks. These flocks later have to be removed either by filtration of a bulk of the water or from a site of accumulation for further treatment.

It would be beneficial if the top water layer volume is made as small as possible. This could be achieved by selecting a proper shape of a vessel, this vessel narrowing to the top. This vessel could be any object that contains the water or the water flows by.

A preferred embodiment of the claimed water treatment process takes place in a Tank 1 as it is presented by a Pic.1. A main part of said Tank 1 has a shape of a cylinder and a top part of said Tank 1 has a form of a cone. Water 7 fills almost all of a volume of said Tank 1. Some small Volume 6 within the conical part of said Tank 1 is occupied by a gas. A Propeller 3 mounted against a wall of said Tank 1 agitates said water and mixes it.

Gas bubbles within said water originate from gas molecules present in said water. The agitation of said water by said Propeller 3 causes turbulences within said water followed by a formation of gas bubbles. Contaminants within said water attach to said gas bubbles and said gas bubbles collect and deliver said contaminants to a water Top 8. Because no flocculants were added to said water said gas bubbles grow in size during rise to said water Top 8.

Said gas bubbles decay on said water Top 8 and release delivered contaminants. As a result with time a top water layer will be enriched with said contaminants. When the treatment process is finished, a predetermined top volume of said water is drained through a separate drainage Valve 5. Said drainage Valve 5 is mounted against the wall close a top of the conical part of said Tank 1.

In another preferred embodiment also presented by the Pic.1 said gas bubbles originate from gas previously dissolved in said water under pressure. Said gas is delivered by a Pipe 2. Said Pipe 2 has a form of a spiral with numerous small holes and said gas moves through said holes into said water and rises through said water. A pressure operated Valve 4 releases an excessive gas from said Volume 6 on the top of said Tank 1. Said gas bubbles are formed within said water after the Valve 4 is opened and the pressure within said water decreases.

In another preferred embodiment said gas bubbles are formed within said water and result both from said pressure decrease and said turbulences caused by said agitation by said Propeller 3.

In another preferred embodiment a Separator is mounted close to said water Top 8 within said Tank 1. Said Separator is a Diaphragm 9, in a construction similar to those in a photo-camera. The purpose of said Separator is to provide further separation of the water layers. During an agitation of said treated water by said Propeller 3 said Diaphragm 9 is opened, but when the treatment process is finished said Diaphragm 9 is closed, separating the enriched with the contaminants top water layer from a main body of said treated water. This separated top portion of said treated water could be treated later by any conventional method while said main water body would be much cleaner afterwards.

In another preferred embodiment of the claimed process both an upper part of said conical part of said Tank 1 is narrow enough and there is enough contaminating agents within said Tank 1 for a process of contaminants concentration on said water Top 8 to result in aggregation of said contaminants within said top water layer. Said aggregation is further followed by large enough flocks formation and eventual precipitation of said flocks into a bulk of said water. Later said water could be treated from said precipitate for example but not limited by this example by filtration.

A Schematics of a preferred embodiment of a continuous treatment process by the described method is presented by the Pic.2 An Arrow shows a direction of the water movement. A FIG. 1 is a view from the top while a FIG. 2 presents a side view of the process. Water initially flows fast by a rocky ramp within some shallow Channel 1. Obstacles 8 located at a bottom of said Channel 1 cause turbulences within said water. Next said water flows by a Pond 2. Said Pond 2 is deep and said water flows comparatively slow through said Pond 2, means comparatively to said water velocity within said Channel 1.

Although said turbulences are caused by said Obstacles 8 located within said Channel 1, because said water moves fast, said turbulences cause formation of gas bubbles only when said water already flows within said Pond 2. Contaminants are attached to said gas bubbles and lifted to a water Top 9 within first part of said Pond 3, or a Zone 3 of gas bubbles formation and rise. As a result a top water layer within said Zone 3 is enriched with delivered by said gas bubbles pollutants.

A Separator 4 is placed within a next zone of said Pond 2 close to said water Top 9. This next zone follows said Zone 3 and is a zone where the process of said gas bubbles formation and rise is mostly finished. Mostly means that a majority of gas bubbles reach said water Top 9 within said Zone 3.

Said Separator 4 has a form of a thin lateral sheet. Said Separator 4 parts some top water layer from a main water body. Said main water body exits said Pond 2 by a Channel 7. Said top water layer, enriched with delivered by gas bubbles pollutants, flows above said Separator 4 and is further diverted by a vertical Bar 5 to flow into a Pipe 6. This part of the water is later treated from accumulated pollutants by any known method.

A problem with a separation of a top water layer from a bulk of it with a help of any separator is that such a separator perturbs water and could cause mixing of water layers. In order to avoid such a mixing a lateral speed of water layers has not to be changed, and a vertical component of water speed must not be created, or at least this vertical speed should be directed upwards. A problem of slowing of the top water layer by friction against this separator has to be addressed also.

In the preferred embodiment also presented by the Pic.2 to avoid or at least to mitigate these problems said Separator 4 is not long and an incline of said Pipe 6 is more then an incline of Channel 7 so said top water layer moves faster then said water main body. Because of this speeds difference in said preferred embodiment a considerable amount of water is removed through said Pipe 6 to be treated later.

This removed part of the water with concentrated contaminants can be treated separately by a repeated described process. As a result of several cycles of this process a volume of water with removed contaminants could be made small. This small volume will be less expensive to treat further from pollutants by any known method.

It would be beneficial if water layers separation takes place prior to enrichment of said top water layer with contaminants. In such a case said top water layer could move much slower then the rest of the water and so a considerable concentration of pollutants within said top water layer takes place.

A Schematics of another preferred embodiment of the continuous treatment is presented also by the Pic.2. Differently from the previous preferred embodiment said Zone 3 is not wide enough and so a majority of gas bubbles are formed, collect contaminants, rise, and decay within a next zone of said Pond 2. Said Separator 4 is placed above this zone of gas bubbles formation and rise Thus said Separator 4 has to perform two tasks simultaneously. The first task is to allow a vast majority of said gas bubbles to rise through said Separator 4. The second task is to suppress a turbulent mixing of top water layer with underlying layers of said water. A problem of said water circular movement within said zone of gas bubbles formation and rise is addressed by a construction of said Pond 2.

To suppress a circular movement of water within said zone of said gas bubbles formation and rise said water main body lateral velocity there has to be uniform or at least not to differ very much. This task is achieved by a shape of said Zone 3. Said Zone 3 is more wide, deep and less inclined then said Channel 1 thus allowing a smooth transition from said Channel 1 to next said zone of gas bubbles formation and rise.

A preferred embodiment of said Separator 4 is presented by a Pic.3. Said Separator 4 is constructed in a form of plain thick lateral sheet. This sheet is constructed from Cells 7 in a form of lattice or honeycomb wherein said cells are opened from both ends and thus said gas bubbles can rise through said Separator 4. A height and width of said individual Cell 7 in said lattice or honeycomb is sufficient enough to prevent a turbulent movement of water through it. For said Separator 4 to be rigid enough Walls 6 of said Cells 7 have to be manufactured from an appropriate material, for example, but not limited to it, from steel or other metal.

Another preferred embodiment of said Separator 4 is as follows. Said Separator 4 consists from a lower and an upper parts. A lower part of said Separator 4 is similar to the previous embodiment presented by the Pic.3. Similarly to the embodiment presented by the Pic.3 this lower part has a form of a thick lateral Sheet 1. Differently to the embodiment presented by the Pic.3 opened from both ends Cells 7 are cone-shaped narrowing to the top.

Said Cells 7 are both long and narrow enough to suppress turbulences within said Cells 7. Said Cells 7 end into thin vertical Pipes 2. Above said lower part of said Separator 4 is an upper part of said Separator 4 presented by a Pic.4. Said upper part is a Tank 10. Said Pipes 2 end into said Tank 10 and do not reach water Surface 9 within said Tank 10. In one of preferred embodiments said vertical Pipes 2 are only within said Tank 10, thus said upper part of said Separator is mounted on the top of said lower part. In another preferred embodiment there is a substantial distance between said upper and lower parts and said upper and lower parts are connected only by long said Pipes 2.

Said gas bubbles rise through said Cells 7 and further trough said Pipes 2 and eventually reach said water Surface 9 within said Tank 5. Said gas bubbles decay at said water Surface 9 leaving delivered contaminants to float on or close to said water Surface 9. A continuous accumulation of said delivered contaminants at said water Surface 9 eventually results in an aggregation followed by a flocculation. Large flocks precipitate to the bottom of said Tank 10 and accumulate there to be further removed for treatment by any known method.

In another embodiment of the described method said Separator 4 also consists of two parts. The lower one is the same with the previous embodiment. The upper part is also presented by the Pic.4. A separate flotation process takes place within said Tank 10. Load of surfactants are added to the water within said Tank 10. Adsorption of said surfactants stabilize gas bubbles within said Tank 10 and thus froth is accumulated on said water Surface 9. Pollutants are removed later altogether with said froth like in any conventional flotation. There has to be an on going addition of said surfactants to the water in the Tank 10 to compensate said adsorption.

Some surfactants molecules would enter said Pipes 2 and go down in the direction of the main water body. However this movement is a diffusion and therefore slow. At the same time fast rising gas bubbles will absorb these molecules within said Pipes 2 and Cells 7. Therefore if the surfactants concentration within the Tank 10 is not excessive, the release of the surfactants into the main water body would not take place. This implies that said surfactants addition has to be a continuous process rather than once in a time.

The idea of an Apparatus for water treatment by gas dissolved under a substantial pressure is based on a very well known fact that a pressure at a bottom of a water tower is determined by the height of this tower and this pressure decreases along the height.

In a preferred embodiment of the claimed Apparatus water is already under a sufficient pressure and there is a substantial amount of gas dissolved within said water. This can take place, for example but not limited to this example, when a groundwater has to be treated. This water can enter directly at a bottom of a water tower. With a further rise a pressure decrease will cause gas bubbles formation within said water and further pollutants removal by said gas bubbles to a top of said water. Further a top layer of said water is dealt with by any of the processes of said water treatment described previously.

In another preferred embodiment said water has to be saturated with some gas prior to entering a bottom of said water tower for further treatment. Gas is delivered to said gas dissolution unit and mixed with said treated water Said gas is dissolved in said water during some time. For example but not limited to this example air can be delivered by some pipe to a bottom of said gas dissolution unit. Gas bubbles will be further released at this bottom and rise through said water, during this process gas molecules being dissolved within said water. An excess of said gas will be collected at a top of said gas dissolution unit and later released through a pressure operated valve.

When a pressure within said treated water later decreases already existing in said water gas bubbles will act as centers of dissolved gas molecules collection. Thus gas bubbles within the water will compete for dissolved gas molecules with contaminants. That is why no gas bubbles should be present in said water at an exit from said gas dissolution unit. Therefore there has to be a sufficient time for all existing within said water gas bubbles to reach a top of said Tunnel 3 prior said water exits from said gas dissolution unit. At the end of this gas saturation process said gas is present within said treated water only as dissolved gas molecules

Thus if an exit of a gas dissolution unit is connected to a bottom of a water tower with a sufficient height no violent eruption of the water takes place. A Pic.5 presents a preferred embodiment of an Apparatus for a Gas Assisted Flotation Treatment of water. An Arrow 1 shows a direction of water movement through claimed Apparatus. Treated water initially flows down through a Shaft 2 of said Apparatus. Said treated water is saturated with gas under a predetermined pressure while moving trough a Tunnel 3 which is a Gas Dissolution Unit. In a case when water to be treated is already pressurized like water from a groundwater source it can enter said Gas Dissolution Unit or said Tunnel 3 directly without moving through said Shaft 2.

Said Tunnel 3 is connected by a Valve 4 to a bottom of a flotation Chamber. Said flotation Chamber comprises three Parts. A first part of said flotation Chamber is a water tower or a Shaft 5. Said Shaft 5 is both narrow and vertical. A length of said Shaft 5 is sufficient enough for a water pressure at the bottom of said Shaft 5 to compensate almost all of the gas pressure within said Tunnel 3. An excess of said gas pressure within said Tunnel 3 over the water tower pressure within said Shaft 5 moves said treated water up through said Shaft 5 when said Valve 4 is opened. Said treated water rises fast through said Shaft 5 because of the small diameter of said Shaft 5.

A pressure drop within said Shaft 5 starts a formation of gas bubbles. However because this process of gas bubbles formation requires time when it takes place said treated water already flows by a second Part of said flotation Chamber. Said second Part of said flotation Chamber is a Pond 6. Said Pond 6 is horizontal and has a wide cross-section. At the end of said Pond 6 there is another Valve 7 that separates said Pond 6 from a third Part of said flotation Chamber Said third Part is a Pipe 8. Said Pipe 8 is narrow with a triangular cross-section. Surfactants could be added when or after said treated water flows through said Valve 4.

Because said Pond 6 is wide and shallow said water moves slow there and a retention time for said water within said Pond 6 is sufficient for all said gas bubbles to reach a top of said water. This retention time coincides with the time of the water saturation within said Gas Dissolution Unit. Froth is concentrated on said water top within said Pond 6.

When a Valve 7 is opened said water flows further into deep and narrow Pipe 8 wherein the accumulated froth with removed contaminants is separated from a main water body for further treatment. After said Pond 6 is empty said Valve 7 is closed and said Valve 4 is opened. Then the treatment cycle repeats.

Another preferred embodiment of the claimed process of a water treatment from pollutants with the claimed Apparatus is also presented by the Pic.5. If a dissolved gas concentration of in the water after a Gas Dissolution Unit exceeds a gas concentration necessary to treat this water then this water with dissolved gas could be used in a Gas Assisted Flotation Treatment of larger volumes of water. This could take place when the contaminants concentration in the water is not large or varies with time. Thus some additional part of the treated water flows bypassing the Gas Saturation Unit directly to the bottom of said Shaft 5 to be mixed with the gas-saturated portion of the water prior to the gas bubbles formation.

If the mixing of these two portions of the water takes place at the time of the gas bubbles formation, then the resulting turbulences would promote the process of gas bubbles formation. Later the process of contaminants removal would go similarly to the previous case of the gas saturated water.

A preferred embodiment of an Apparatus for a continuous water treatment with non-stable gas bubbles is presented by the Pic.6. An Arrow 1 shows a direction of water movement through said Apparatus. Said water enters said Apparatus by flowing down through a vertical Shaft 2. Said vertical Shaft 2 is connected at the bottom to a second Part of said Apparatus which is a Gas Saturation Unit. Said Gas Saturation Unit is a Tunnel 3 connected at the other end to a third Part of said Apparatus. In a case when water to be treated is already pressurized like water from a groundwater source it can enter directly said Gas Dissolution Unit. In a case when there is a desired concentration of dissolved gas within said water said water could enter the third part of said Apparatus directly, thus omitting said Gas Dissolution Unit.

While moving through said Tunnel 3 said water is saturated with gas delivered to said Tunnel 3 under a predetermined pressure, said gas being not necessarily air. An excess of said gas is concentrated at the top of said Tunnel 3 and exits from said Tunnel 3 so no gas bubbles are present within treated water at an exit of said Tunnel 3. Eventually said water moves into a bottom part of a vertical Shaft 4 which acts as a Part 1 of a flotation Chamber. Surfactants-flotation promoters could be added at the end of said Tunnel 3.

Said flotation Chamber comprises several parts following each other. Initially within said flotation Chamber said water rises by flowing through a Shaft 4. Said Shaft 4 is both vertical and narrow and a pressure drop within said Shaft 4 initiates a process of gas bubbles formation there. Because said water moves fast through said Shaft 4 gas bubbles only start to form and to collect pollutants within said Shaft 4.

Further said water flows through a Part 2 of said flotation Chamber which is a Tunnel 5. Said Tunnel 5 is of a much larger diameter then said Shaft 4. Thus said water moves much more slowly within said Tunnel 5 wherein also a majority of said gas bubbles are formed and reach a top of said water within said Tunnel 5. As it is presented by the Pic.6 a height of said Shaft 2 is substantially more then a height of said Shaft 4 and said water is under a substantial pressure within said Tunnel 5.

At a said Tunnel 5 top there is a set of conical Cavities 6. Said Cavities 6 end into Pipes 7. Said Pipes 7 are both thin and vertical. Said Pipes 7 end into the Tank 10 presented by the Pic.4, these Pipes 7 are the same with Pipes 2 of the Pic.4. Said substantial pressure within said Tunnel 5 is sufficient enough for said conical Cavities 6, and the following Pipes 7, and a part of said Tank 10 to be filled with water.

Said water flows further by said Tunnel 5 and leaves the described Apparatus. Said gas bubbles rise to the top of said Tunnel 5 and further though conical Cavities 6. Eventually said gas bubbles rise through Pipes 7 and decay at said water Top 9 within said Tank 10. As it was presented previously within said Tank 10 a removal of delivered by said gas bubbles contaminants takes place, either through a process of an aggregation and a precipitation, or as a flotation.

Another preferred embodiment of the claimed process of a water treatment from pollutants with the claimed Apparatus presented by the Pic.6 is as follows. If a dissolved gas concentration of in the water after a Gas Saturation Unit exceeds a gas concentration necessary to treat this water then this water with dissolved gas could be used for treatment of additional volumes of water. This could take place when the contaminants concentration in the water is not large or varies with time. Thus some additional part of the treated water flows bypassing the Gas Saturation Unit directly to the bottom of said Shaft 4 to be mixed with the gas-saturated portion of the water prior to the gas bubbles formation.

If the mixing of these two portions of the water takes place at the time of the gas bubbles formation, then the resulting turbulences would promote the process of gas bubbles formation. Later the process of contaminants removal would go similarly to the previous case of the gas saturated water.

The presented invention may be embodied in other specific forms without departing from the ideas of it. Thus the presented embodiment have to be considered only as illustrated and not restrictive. Therefore the scope of the invention is defined by the claims rather then by presented description.

We claim:

1. While a conventional flotation treatment of water comprises:
a. an addition of surfactants to said water in order to stabilize later gas bubbles
b. an optional addition of surfactants-promoters of flotation to said water
c. a formation of said gas bubbles within said water
d. further stabilization of said gas bubbles by said surfactants adsorption
d. a collection of contaminants by an adhesion to said gas bubbles
e. a rise of said gas bubbles with attached said contaminants to a top of said water
f. a froth formation on said top of said water said froth containing collected contaminants
g. a removal of said froth for further treatment
a claimed method of water treatment from polluting agents or contaminants for drinking or for any other purpose comprises:
a. an optional addition of surfactants-promoters of flotation to said water
b. a formation of said gas bubbles within said water
c a collection of said contaminants by an adhesion to said gas bubbles
d a rise of said gas bubbles with said pollutants attached to a top of said water wherein said gas bubbles decay and release said contaminants
e an accumulation of said contaminants within a top water layer wherein said gas bubbles formation within said water results from any of the following:
f. previously dissolved within said water under normal atmospheric pressure gas means said gas bubbles formation is caused by stirring, or disturbances, or any other turbulences within said water
g. a pressurization-depressurization cycle means in said pressurization-depressurization cycle gas is initially dissolved within said water under a substantial pressure and a formation of said gas bubbles is caused by later said substantial pressure decrease
h. some chemicals addition to said water means said chemicals cause a reaction within said water in said chemical reaction gas molecules are released into said water
i. by any combination of said turbulences, pressurization-depressurization cycle, and chemical reaction within said water whereby comparing to a flotation the claimed process substantially increases a speed of contaminants removal from a body of the treated water.

2. A Separator to separate said top water layer with delivered and released contaminants in the process claimed by the claim 1
means said Separator prevents or reduces a mixing of said top water layer with underlying water layers
whereby said Separator makes a process of said top water layer further treatment easier.

3. A Separator to separate said top water layer as it is claimed by the claim 2 means said Separator allows said gas bubbles to rise through said Separator but said Separator prevents or reduces a turbulent mixing of said top water layer with underlying water layers
whereby said Separator enables said top layer to be immobilized or to move slowly comparing to said water thus allowing a further concentration of removed contaminants within said top water layer.

4. A method to treat water by a Separator claimed by the claim 3 for a flotational treatment of said top water layer
means said gas bubbles within said Separator are stabilized by surfactants addition and collected by said gas bubbles contaminants are later removed from said water with froth

5. A process as it is claimed by the claim 1 wherein
said top water layer enriched with said contaminants is separated and removed from a main body of said water for further treatment

6. A process as it is claimed by the claim 1 wherein
accumulated within said top water layer contaminants further aggregate together and later said aggregated contaminants return to said water
whereby making a process of said water further treatment easier.

7. A process as it is claimed by the claim 1 wherein
accumulated within said top water layer contaminants further aggregate together and said top water layer is later removed with these aggregated contaminants
whereby making a process of said top water layer further treatment easier.

8. A process as it is claimed by the claim 1 wherein
accumulated within said top water layer contaminants further aggregate together, said aggregated contaminants r continue to grow in size until large flocks of contaminants are formed
said flocks further precipitate to either a bulk of said water or to any designated site of accumulation forming a precipitate
said flocks, or precipitate, or any combination of said flocks and precipitate are later removed by any known method
whereby said water treatment from contaminants does not require an addition of chemicals.

9. A Separator to separate precipitating flocks of contaminants in the process claimed by the claim 8
means said Separator allows said gas bubbles to rise through said Separator
but said Separator prevents or reduces a turbulent mixing of said top water layer with underlying water layers
and said Separator collects precipitated flocks of contaminants
whereby said Separator does not allow said precipitated flocks of contaminants to return to said main water body and thus makes a process of further removal of said precipitated flocks of contaminants easier.

10. An Apparatus for a continuous treatment of water by the method claimed in the claim 1, or by a Gas Assisted Flotation, or by a Dissolved air Flotation
said Apparatus comprising one or more of not necessarily vertical shafts, pipes, tunnels, chambers, or any other similar vessels said water eventually flows by, said vessel or vessels constitute a flotation Unit with a water tower within said flotation Unit,
said water initially contains dissolved under a substantial pressure gas
and said water enters a lower part of said flotation Unit and rises by flowing through said water tower, and said water within said water tower maintains a substantial pressure at a bottom of said flotation Unit
means while said water rises by moving through said flotation Unit the pressure within said water decreases and causes gas bubbles formation within said flotation Unit from previously dissolved gas molecules
and within said flotation Unit said contaminants are attached to said gas bubbles, said gas bubbles further rise and take contaminants with them, and deliver these attached contaminants to a top water layer
whereby contaminants are removed from a main water body and a productivity of this Apparatus allows to treat large volumes of water.

11. An Apparatus as it is claimed by the claim 10
wherein said water prior to entering said flotation Unit enters and later flows by some Gas Dissolution Unit
means within Gas Dissolution Unit molecules of said gas are dissolved within said water under a predetermined pressure
and an exit of said Gas Dissolution Unit is connected to an entrance of said flotation Unit either directly or through some connecting shaft, tunnel, pipe or a plurality of any vessels said water flows by
whereby making it possible to treat pressurized water without a substantial concentration of dissolved gas within said water.

12. An Apparatus as it is claimed by the claim 11 wherein only a first part of said water flows through said Gas Dissolution Unit
wherein another part of said water is mixed with said first part only after said first part leaves said Gas Dissolution Unit and prior to a rise of said water through said flotation Unit
whereby increasing a volume of treated water.
